(19) United States
(12) Patent Application Publication
(10) Pub. No.: US 2002/0039688 A1
(43) Pub. Date: Apr. 4, 2002

(54) LACTONE SOLVENTS FOR ELECTROCHEMICAL CELLS

(76) Inventors: JEREMY BARKER, REDMOND, WA (US); FENG GAO, ANN ARBOR, MI (US); EDWARD P. THURSTON, HOBOKEN, NJ (US)

Correspondence Address: HARNESS, DICKEY & PIERCE, PLC, P.O. BOX 828, BLOOMFIELD HILLS, MI, 48303, US

(21) Appl. No.: 09/408,065

(22) Filed: Sep. 29, 1999

(51) Int. Cl. H01M 10/40; H01M 4/52; H01M 4/50

(52) U.S. Cl. 429/326; 429/331; 429/332; 429/333; 429/342; 429/223; 429/224; 429/231.1; 429/231.3

(57) ABSTRACT

The present invention provides an electrochemical cell having an electrolyte comprising a solvent and a solute, the solute comprising a lithium salt, and the solvent comprising an organic solvent selected from the group of lactones.

### FIELD OF THE INVENTION

This invention relates to electrolytes which function as a source of alkali metal ions for providing ionic mobility and conductivity, and more particularly to electrolytic cells where such electrolytes function as an ionically conductive path between cell electrodes.

### BACKGROUND OF THE INVENTION

Electrolytes are an essential member of an electrolytic cell or battery. In one arrangement, a battery or cell comprises electrodes (i.e., anode and cathode) separated by an intermediate separator element containing an electrolyte solution through which ions from a source electrode material move between the cell electrodes during the charge/discharge cycles of the cell. The present invention is particularly useful for making such electrolytic cells in which the ion source electrode is a lithium compound or other material capable of intercalating lithium ions (Li⁺ions), and where an electrode separator element comprises a polymeric matrix made ionically conductive by the incorporation of an organic solution of a dissociable lithium salt which provides ionic mobility.

### Early Lithium Metal Electrolytic Cells

Early rechargeable lithium electrolytic cells utilized lithium metal electrodes as the ion source in conjunction with positive electrodes comprising compounds capable of intercalating the Li⁺ ions within their structure during cell discharge. Such cells relied, for the most part, on separator structures or membranes which physically contained a measure of fluid electrolyte, usually in the form of a solution of a lithium compound, and which also provided a means for preventing destructive contact between the electrodes of the cell. Sheets or membranes ranging from glass fiber, filter paper or cloth to microporous polyolefin film or nonwoven organic or inorganic fabrics have been saturated with solutions of an inorganic lithium compound, such as LiClO₄, LiPF₆, or LiBF₄, in an organic solvent to form such electrolyte/separator elements. The fluid electrolyte bridge thus established between the electrodes has effectively provided the necessary Li⁺ ion mobility at conductivities in the range of about 10⁻³ S/cm.

### Ion, Rocking Chair Cells, and Polymer Cells

Lithium metal anodes cause dendrite formation during charging/recharging cycles which eventually leads to internal cell short-circuiting. Some success has been achieved in combating this problem through the use of Li⁺ ion cells in which both electrodes comprise intercalation materials, such as lithiated metal oxide and carbon (U.S. Pat. No. 5,196,279), thereby eliminating the lithium metal which promotes the deleterious dendrite growth. Another approach to controlling the dendrite problem has been the use of continuous films or bodies of polymeric materials which provide little or no continuous free path of low viscosity fluid in which the lithium dendrites may propagate. These materials may comprise polymers, e.g., poly (alkylene oxide), which are enhanced in ionic conductivity by the incorporation of a salt, typically a lithium salt such as LiClO₄, LiPF₆, or the like. A range of practical ionic conductivity, i.e., over about 10⁻⁵ to 10⁻³ S/cm, was only attainable with these polymer compositions at well above room temperature, however. See U.S. Pat. No.'s 5,009,970 and 5,041,346.

### “Solid” and “Liquid” Batteries of the Prior Art

Electrolytic cells containing an anode, a cathode, and a solid, solvent-containing electrolyte incorporating an inorganic ion salt were referred to as “solid batteries”. See U.S. Pat. No. 5,411,820. These cells offer a number of advantages over electrolytic cells containing a liquid electrolyte (i.e., “liquid batteries”), including improved safety factors. Despite their advantages, however, the manufacture of these solid batteries requires careful process control to minimize the formation of impurities. Solid batteries employ a solid electrolyte matrix interposed between the cathode and an anode. The inorganic matrix may be non-polymeric [e.g., β-alumina, silver oxide, lithium iodide, etc.] or polymeric [e.g., inorganic (polyphosphazene) polymers], whereas the organic matrix is typically polymeric. Suitable organic polymeric matrices are well known in the art and are typically organic polymers obtained by polymerization of a suitable organic monomer as described, for example, in U.S. Pat. No. 4,908,283.

Examples of solvents known in the art are propylene carbonate, ethylene carbonate, tetrahydrofuran, glyme (dimethoxyethane), diglyme, tetraglyme, dimethylsulfoxide, dioxolane, sulfolane, diethoxyethane, and the like. These are examples of aprotic (nonhydroxylic), polar solvents. More recently, a highly favored electrolyte/separator film is prepared from a copolymer of vinylidene fluoride and hexafluoropropylene. Methods for making such films for cell electrodes and electrolyte/separator layers are described in U.S. Pat. No.'s 5,418,091, 5,460,904, and 5,456,000, assigned to Bell Communications Research, each of which is incorporated herein by reference in its entirety. A flexible polymeric film useful as an electrode separator or electrolyte member in electrolytic devices, such as rechargeable batteries, comprises a copolymer of vinylidene fluoride with 2% to 25% hexafluoropropylene. The film may be cast or formed as a self-supporting layer retaining about 20% to 70% of a high-boiling-point solvent or solvent mixture comprising such solvents as ethylene carbonate or propylene carbonate. The film may be used in such form or after leaching of the retained solvent with a film-inert, low-boiling-point solvent to provide a separator member into which a solution of electrolytic salt is subsequently imbibed to displace retained solvent or replace solvent previously leached from the polymeric matrix.

### Electrolyte Performance

Regardless of which technique is used in preparing an electrolyte/separator, problems occur, including operability of the electrolyte only in a relatively narrow temperature range, loss of effectiveness of the electrolyte, and electrolyte degradation. There is presently no effective means to maintain the serviceability of the electrolyte over a broad temperature range.

In view of the above, it can be seen that it is desirable to have an improved electrolyte which is operable over a relatively broad temperature range, and which maintains cell capacity in a variety of electrolyte/separator configurations, including those described above as exemplary.

### SUMMARY OF THE INVENTION

The present invention provides a novel electrolyte solvent which is usable with a variety of carbonaceous and metal compound electrode active materials, providing improved performance over a broad temperature range, and which is stabilized to maintain cell capacity over a number of cycles. The electrolyte includes a specifically selected class of solvents, and solvent combinations using such new solvents. The new solvents, when used as co- solvents, enhance the operable temperature range of the solvent mixture.

The solvents of the invention include lactones, particularly methylated, ethylated, and propylated forms of γ-butyrolactone, as well as β-propiolactones, all of which are compounds generally characterized with lower melting points and higher boiling points as compared to the ranges observed for conventional solvents, such as dimethyl carbonate (DMC) or diethyl carbonate (DEC). The solvents are useful as both high and low temperature solvents, and are useful for low temperature cell/battery applications such as start, light, ignition (SLI). The compounds usable as solvents according to the invention are lactones having a low melting point on the order of 18° C. or less and a high boiling or decomposition temperature on the order of 150° C. or more. Any of the lactone solvents of the invention may be used as the sole solvent, or in combination with other solvents in a solvent mixture.

In one embodiment, a solvent mixture also comprising ethylene carbonate (EC) and dimethyl carbonate (DMC) further includes any of the lactone solvents of this invention. In one embodiment, the combined amount of the EC and DMC is greater, on a weight basis, than the amount of the selected lactone(s). In another embodiment, the selected lactone(s) of the invention form a significant part of the solvent mixture. In another embodiment, the solvent mixture further comprises one or more other organic solvents along with the selected lactone(s), and with the EC and DMC mixture.

When an additional organic solvent or solvents is included with the solvent mixture, it is preferred that such solvent be selected from the group of carbonates, other lactones, propionates, five member hetercyclic ring compounds, and organic solvent compounds having a low alkyl (1-4 carbon) group connected through an oxygen to a carbon, and comprising C/O/C bonds.

In the case where one or more additional organic solvents is used in a solvent mixture according to the present invention, the added solvents are preferably organic solvents having a boiling point of about 80° C. to about 300° C., and are capable of forming a solute with lithium salts. Preferably the added solvents are also characterized by being aprotic, polar solvents. Preferred additional organic solvents include ethylene carbonate (EC), dimethyl carbonate (DMC), propylene carbonate (PC), methyl ethyl carbonate (MEC), diethyl carbonate (DEC), dipropyl carbonate (DPC), butylene carbonate (BC), dibutyl carbonate (DBC), vinylene carbonate (VC), and diethoxy ethane (DEE). The relative amounts of the added solvents and the selected lactone(s) may vary so long as the lactone of the invention is present.

One desirable solvent mixture comprises the selected lactone of the present invention, and EC:DMC in a weight ratio of about 2:1. The lactone solvent is present in an amount of up to about 30%; desirably up to about 20%; and more desirably up to about 10%. These ranges are optimized on the basis of performance and relative cost.

Advantageously, the solvent ester of the invention is usable with a variety of cell electrode active materials, including lithium-containing compounds such as LiMn₂O₄, LiNiO₂, LiCoO₂, LiNiVO₄, and LiCoₓNi₁₋ₓO₂. It is most preferred that the electrode active material be lithium manganese oxide represented by the nominal general formula: Li₁₊ₓMn₂₋ₓO₄ (−0.2<×0.2)

Advantageously, the lactone solvent of the invention is usable with graphite active material consisting of particles which have an interlayer distance spacing of 002 planes as determined by X-ray diffraction of 0.33 to 0.34 nanometers; a crystallite size in the direction of C-axis (L_{c}) being greater than about 20 nanometers and less than about 2000 nanometers; and at least 90% by weight of the graphite particles having a size less than about 60 microns. It is most preferred that the graphite particles have a BET surface area greater than about 0.3 meters square per gram and up to about 35 meters square per gram.

Advantageously, electrochemical cells made according to the present invention exhibit good performance even with carbonaceous electrode active materials and with transition metal active electrode materials, which are materials known to show poor performance when used with conventional organic solvents.

Objects, features and advantages of the invention include: An improved electrochemical cell or battery having good charging and discharging characteristics; a large discharge capacity; good integrity over a long life cycle; operability over a large temperature range; and stability with respect to carbonaceous and graphitic electrode active material, and metal oxide electrode material.

These and other objects, features, and advantages of the present invention will become apparent from the following description of the preferred embodiments, claims, and accompanying drawings.

### BRIEF DESCRIPTION OF THE DRAWINGS

FIG. 1 is a diagrammatic representation of a typical laminated lithium-ion battery cell structure which is prepared with the electrolyte solvent of the present invention.

FIG. 2 is a voltage/capacity plot, showing cumulative capacity (mAh), for a BG-35 graphite carbon electrode cycled with a lithium metal counter-electrode using constant current cycling at ±0.2 milliamps per square centimeter, between 0.01 and 2.0 volts, using 19 milligrams of the BG-35 active material. The electrolyte was 1 molar LiPF₆ in a solution of ethylene carbonate (EC) and dimethyl carbonate (DMC), 2:1 wt. EC:DMC; and including 10% by weight of a lactone which is 3-methyl-γ-butyrolactone, also known as α-methyl-γ-butyrolactone.

FIG. 3 is similar to FIG. 2, and is for a cell the same as FIG. 2 except that the lactone is 5-methyl-γ-butyrolactone, also known as γ-valerolactone

FIG. 4 is similar to FIG. 2, and is for a cell the same as FIG. 1 except that the lactone is γ-butyrolactone, 10% by weight.

FIG. 5 is a voltage/capacity plot showing cumulative capacity (mAh) for a lithium manganese oxide (LMO) electrode cycled with a lithium metal counter-electrode using constant current cycling at ±0.2 milliamps per square centimeter, between 3.0 and 4.3 volts, using 30 milligrams of the LMO active material. The electrolyte was 1 molar LiPF₆ in a solution of 2:1 by weight of EC:DMC, and including 10% by weight 3-methyl-γ-butyrolactone.

FIG. 6 is similar to FIG. 5, and is for a cell the same as FIG. 5 except that the lactone is γ-butyrolactone.

FIG. 7 is a two-part graph showing the results of testing two cells each having different electrolytes. Each cell was a rocking chair battery, having an anode comprising BG-35 active material cycled with a counter-electrode comprising LMO active material. FIG. 7A shows Coulombic Efficiency and FIG. 7B shows Discharge Capacity, each versus Cycles. The cell charge and discharge are at ±1 milliamp hour per centimeter square, between 3 and 4.2 volts for over 120 cycles. The negative electrode contained 570 milligrams of the BG-35 active material and the positive electrode contained 1710 milligrams of the LMO active material. The surface area of the positive electrode was 48 square centimeters and the surface area of the negative electrode was 48 square centimeters. The electrolyte of one cell was comprised 10% by weight methyl-γ-butyrolactone in 90% by weight of 1 molar LiPF₆ EC/DMC. The weight ratio of EC/DMC was 2:1. The electrolyte of the other cell comprised 10% by weight γ-butyrolactone in 90% by weight of 1 molar LiPF₆ EC/DMC. The net ratio of EC/DMC was 2:1.

### DESCRIPTION OF THE ILLUSTRATED EMBODIMENTS

In the present state of the art, the use of graphite as a negative electrode material presents a problem when used with several carbonate electrolyte solvents. Cells suffer from very poor reversible capability and decomposition. In view of these difficulties, propylene carbonate is said to be usable only with non-graphitic anodes and is not usable with crystalline, ordered planar structure graphitic anodes. It has recently been suggested to use DMC in combination with EC for any type of carbonaceous anode. See, e.g., U.S. Pat. No.'s 5,352,548 and 5,192,629, each of which is incorporated by reference in its entirety. However, such electrolyte is undesirable since the DMC may evaporate leaving behind the EC, which itself may solidify, rendering the cell useless. Thus, the effective temperature range for the operation of such cells is unattractive.

In one embodiment, the electrolyte of the invention comprises lactones useable alone as a solvent for an electrolyte. In another embodiment, the electrolyte comprises a solvent mixture containing any of the solvent lactones of the invention in combination with other organic solvents. Such lactone solvents have lower melting points and higher boiling points as compared to the range observed for conventional electrolyte solvents, such as DMC, which does not have a high boiling point and is thus unsuited for high temperature operation. DMC is likewise not suitable for low temperature operation due to its high melting point. The lactones of the invention have further lower melting points and higher boiling points, giving them utility as both high and low temperature solvents. Therefore, the advantages of temperature spread between the melting point and the boiling point is achieved by the lactones of the invention. The preferred lactones, the physical characteristics of which are shown in Table I, include methylated, ethylated, and propylated forms of γ-butyrolactones, as well as β-propiolactone. The lactone solvent 5-methyl-γ-butyrolactone is also known as γ-valerolactone.

Any of the selected lactones of the invention are most preferably used in a solvent mixture which includes one or more other organic solvents. Preferably, such one or more other organic solvent each have a boiling point of about 80° C. to about 300° C., and are each capable of forming a solute with lithium salts.

Even a small amount of the lactone solvent of the invention is helpful to the mixture; the lower limit is therefore greater than zero. However, in a mixture, the practical range is up to 30% by weight in the solvent mixture, this range being more preferably up to about 20%, and most preferably up to about 10%. The lactones are effective in electrolyte solutions comprising a solute consisting essentially of a salt of lithium, and a solvent consisting essentially of one or more aprotic, polar solvent compounds in combination with the selected lactone(s).

Preferably, the aprotic, polar solvent is selected from the group consisting of carbonates, lactones besides those of the invention, propionates, five member ring compounds, and organic solvent compounds having a low alkyl group (1-4 carbons) connected through an oxygen to a carbon and comprising C—O—C bonds. Examples are chain esters and cyclic esters. It is most preferred that the aprotic, polar solvent is a carbonate selected from the group consisting of PC, EC, MEC, DEC, DPC, DMC, BC, DBC, VC, and mixtures thereof. Note that methyl ethyl carbonate (MEC) and ethyl methyl carbonate (EMC) are used interchangeably. The physical characteristics of these solvents are shown in Table II.

An electrochemical cell or battery incorporating the novel family of lactone solvents of the invention will now be described. Note that the preferred cell arrangement described here is illustrative only and is not limiting of the present invention, as will be understood by those of skill in the art. Experiments based on full and half cell arrangements were conducted as per the following description.

Polymeric electrolytic cells comprise polymeric film composition electrodes and separator membranes. In particular, rechargeable lithium battery cells comprise an intermediate separator element containing an electrolyte solution through which Li⁺ ions from a source electrode material move between cell electrodes during the charge/discharge cycles of the cell. In such cells an ion source electrode is a lithium compound or other material capable of intercalating Li⁺ ions. An electrode separator membrane comprises a polymeric matrix made ionically conductive by the incorporation of an organic solution of a dissociable lithium salt which provides ionic mobility. Strong, flexible polymeric electrolytic cell separator membrane materials retain electrolyte lithium salt solutions and remain functional over temperatures ranging well below room temperature. These electrolyte membranes are used either in the usual manner as separator elements with mechanically assembled battery cell components, or in composite battery cells constructed of successively coated layers of electrode and electrolyte compositions.

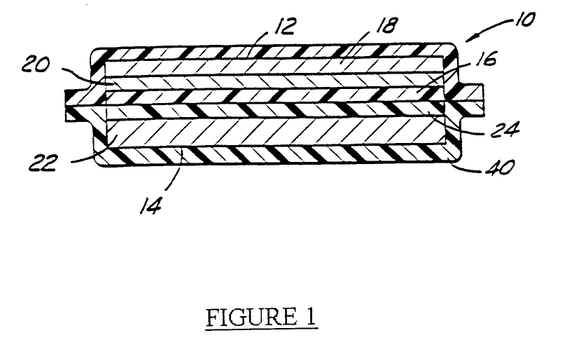

Before further describing the invention, the construction of a typical ion cell will now be described with reference to FIG. 1.

A typical laminated battery cell structure 10 is depicted in FIG. 1. It comprises a negative electrode side 12, a positive electrode side 14, and an electrolyte/separator 16 therebetween. Negative electrode side 12 includes current collector 18, and positive electrode side 14 includes current collector 22. A copper collector foil 18, preferably in the form of an open mesh grid, upon which is laid a negative electrode membrane 20 comprising an intercalation material such as carbon or graphite or low-voltage lithium insertion compound, dispersed in a polymeric binder matrix. An electrolyte separator film 16 membrane of plasticized copolymer is positioned upon the electrode element and is covered with a positive electrode membrane 24 comprising a composition of a finely divided lithium intercalation compound in a polymeric binder matrix. An aluminum collector foil or grid 22 completes the assembly. Protective bagging material 40 covers the cell and prevents infiltration of air and moisture.

The lactone-containing electrolyte solvents of the present invention may of course be utilized in a multicell battery configuration (not shown) which, as is known in the art, is prepared with a copper current collector, a negative electrode, an electrolyte/separator, a positive electrode, and an aluminum current collector. Tabs of the current collector elements are provided to form respective terminals for the battery structure.

The relative weight proportions of the components of the positive electrode are generally: 50-90% by weight active material; 5-30% carbon black as the electric conductive diluent; and 3-20% binder chosen to hold all particulate materials in contact with one another without degrading ionic conductivity. Stated ranges are not critical, and the amount of active material in an electrode may range from 25-85 weight percent. The negative electrode comprises about 50-95% by weight of a preferred graphite, with the balance constituted by the binder. A typical electrolyte separator film comprises approximately two parts polymer for every one part of a preferred fumed silica. Before removal of the plasticizer, the separator film comprises about 20-70% by weight of the composition; the balance constituted by the polymer and fumed silica in the aforesaid relative weight proportion. The conductive solvent comprises the solvent of the invention and suitable salts. Desirable salts and solvent/salt ratios are described in U.S. Pat. No.'s 5,712,059 and 5,418,091. One example is a mixture in a weight ratio of about 90 parts or more of solvent to 10 parts or less of salt. Therefore, the range of salt content may be very broad.

Those skilled in the art will understand that any number of methods may be used to form films from the casting solution, employing for instance conventional meter bar or doctor blade apparatus. It is usually sufficient to air-dry the films at moderate temperature to yield self-supporting films of copolymer composition. Lamination of assembled cell structures is accomplished through conventional means by pressing between metal plates at a temperature of about 120° C.-160° C. Subsequent to lamination, the battery cell material may be stored either with the retained plasticizer or as a dry sheet after extraction of the plasticizer with a selective low-boiling point solvent. The plasticizer extraction solvent is not critical; methanol or ether are often used, by way of example.

Separator membrane element 16 is generally polymeric and prepared from a composition comprising a copolymer. A preferred composition is the 75% to 92% vinylidene fluoride (VdF) with 8% to 25% hexafluoropropylene (HFP) copolymer (available commercially from Atochem North America as KYNAR FLEX) and an organic solvent plasticizer. Such a copolymer composition is also preferred for the preparation of the electrode membrane elements, since subsequent laminate interface compatibility is ensured. The plasticizing solvent may be one of the various organic compounds commonly used as casting solvents, for example carbonates. Higher-boiling plasticizer compounds such as dibutyl phthalate, dimethyl phthalate, diethyl phthalate, and tris butoxyethyl phosphate are particularly suitable. Inorganic filler adjuncts, such as fumed alumina or silanized fumed silica, may be used to enhance the physical strength and melt viscosity of a separator membrane and, in some compositions, to increase the subsequent level of electrolyte solution absorption.

In the construction of a lithium-ion battery, a current collector layer of aluminum foil or grid is overlaid with a positive electrode film, or membrane, separately prepared as a coated layer of a dispersion of intercalation electrode composition. This is typically an intercalation compound such as LiMn₂O₄, LiCoO₂, or LiNio₂ powder in a copolymer matrix solution, which is dried to form the positive electrode. An electrolyte/separator membrane is formed as a dried coating of a composition comprising a solution containing VdF:HFP copolymer and a plasticizer solvent is then overlaid on the positive electrode film. A negative electrode membrane formed as a dried coating of a powdered carbon or other negative electrode material dispersion in a VdF:HFP copolymer matrix solution is similarly overlaid on the separator membrane layer. A copper current collector foil or grid is laid upon the negative electrode layer to complete the cell assembly. Therefore, the VdF:HFP copolymer composition is used as a binder in all of the major cell components, positive electrode film, negative electrode film, and electrolyte/separator membrane. The assembled components are then heated under pressure to achieve heat-fusion bonding between the plasticized copolymer matrix electrode and electrolyte components, and to the collector grids, to thereby form an effective laminate of cell elements. This produces an essentially unitary and flexible battery cell structure.

Examples of forming cells containing metallic lithium anode, intercalation electrodes, solid electrolytes and liquid electrolytes can be found in U.S. Pat. No.'s 4,668,595, 4,830,939, 4,935,317, 4,990,413, 4,792,504, 5,037,712, 5,262,253, 5,300,373, 5,435,054, 5,463,179, 5,399,447, 5,482,795, and 5,411,820, each of which is incorporated herein by reference in its entirety. Note that the older generation of electrochemical cells contained organic polymeric and inorganic electrolyte matrix materials, with the polymeric being most preferred. The polyethylene oxide of U.S. Pat. No. 5,411,820 is an example. More modern examples are the VDF:HFP polymeric matrix. Examples of casting, lamination and formation of electrochemical cells using VdF:HFP are as described in U.S. Pat. No.'s 5,418,091, 5,460,904, 5,456,000, and 5,540,741, assigned to Bell Communications Research, each of which is incorporated herein by reference in its entirety.

As described earlier, the electrochemical cell which utilizes the novel solvents of the invention may be prepared in a variety of ways. In one embodiment, the negative electrode may be metallic lithium. In more desirable embodiments, the negative electrode is an intercalation active material, such as metal oxides and graphite. When a metal oxide active material is used, the components of the electrode are the metal oxide, electrically conductive carbon, and binder, in proportions similar to that described above for the positive electrode. In a preferred embodiment, the negative electrode active material is graphite particles. When forming cells for use as batteries, it is preferred to use an intercalation metal oxide positive electrode and a graphitic carbon negative electrode. Various methods for fabricating electrochemical cells and batteries and for forming electrode components are described herein. The invention is not, however, limited by any particular fabrication method or arrangement as the novelty lies in the unique electrolyte solvents.

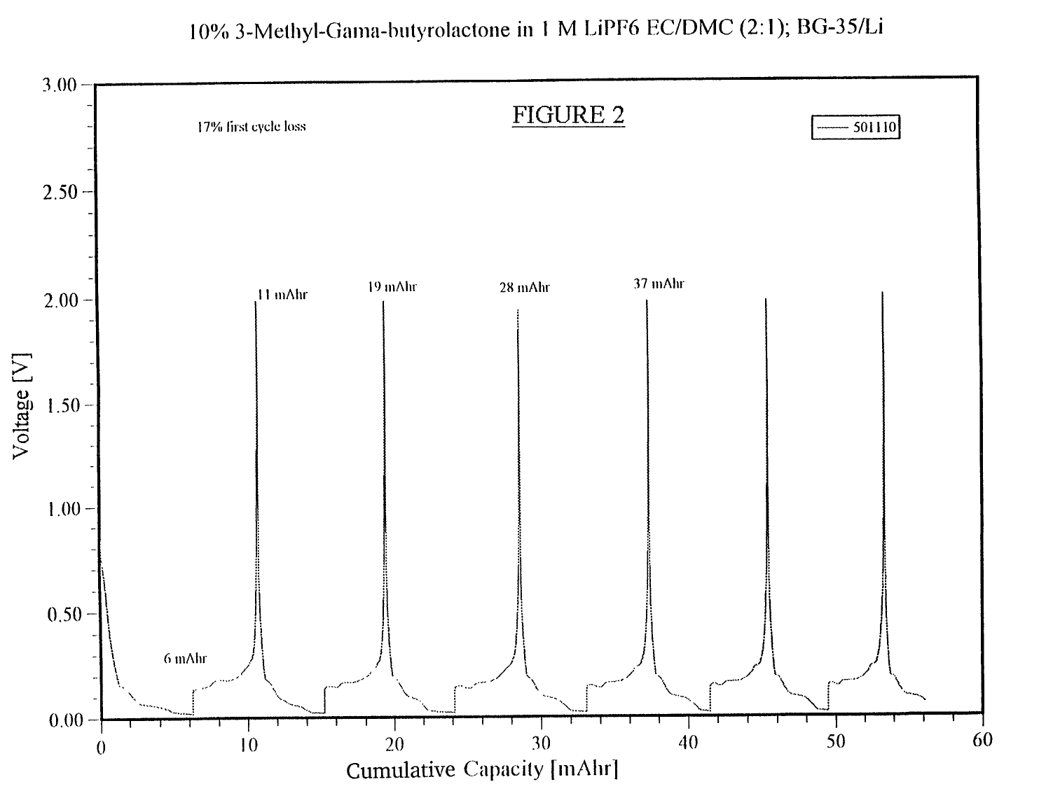

Performance data for several preferred solvent mixtures of the invention, as well as comparative examples, are shown in FIGS. 2-6, as a result of testing in actual cells, which examples are described below. And while the exemplary embodiments of the invention do not relate the testing of all of the aforedescribed lactone electrolyte solvents of this invention, those of skill will understand, with the benefit of this disclosure, the substitutability of the solvents and solvent mixtures claimed and disclosed.

### EXAMPLE I And II

### Examples I And II Cell Construction

A graphite electrode was fabricated by solvent casting a slurry of BG-35 graphite, binder, plasticizer, and casting solvent. The graphite, BG-35, was supplied by Superior Graphite, Chicago, Ill. The BG series is a high purity graphite derived from a flaked natural graphite purified by heat treatment process. The physical features are given in Table III. The binder was a copolymer of polyvinylidene difluoride (PVdF) and HFP in a weight ratio of PVdF to HFP of 88:12. This particular binder, KYNAR FLEX 2801, is commercially available from Atochem Corporation. An electronic grade solvent was used. The slurry was cast onto glass and a free standing electrode was formed as the casting solvent evaporated. The electrode composition was approximately as follows on a dry weight % basis: 60% graphite; 16% binder; 21% plasticizer and 2% conductive carbon.

The counter-electrode was lithium metal. A glass fiber separator was used between the electrodes to prevent them from electrically shorting. An electrochemical cell of the first electrode, separator, and counter-electrode was formed.

The electrolyte used to form the completed final cell or battery comprised a solution of EC, DMC, and one of the lactones of the inventive group. Two different lactones were tested. One was 3-methyl-γ-butyrolactone (2(3H) Furanone, dihydro-3-methyl-), also known as α-methyl-γ-butyrolactone, in the amount of 10% by weight 3-methyl-γ-butyrolactone and 90% by weight EC/DMC. The other lactone tested was 10% by weight 5-methyl-γ-butyrolactone (2(3H) Furanone, dihydro-5-methyl-) and 90% by weight EC/DMC. In both cases the EC:DMC weight ratio was 2:1, and the electrolyte solution contained 1 molar LiPF₆ salt. The two electrodes were maintained in separated condition using a glass fiber layer. The electrolyte solution interpenetrated the void spaces of the glass fiber layer.

### Example I Results

The results of constant current cycling (at 23° C.±1° C.) for the cell incorporating 3-methyl-γ-butyrolactone are shown in FIG. 2, which represents a voltage/capacity plot of BG-35 graphite cycled with a lithium metal electrode using constant current cycling at ±0.2 milliamps per square centimeter, between 0.01 and 2.0 volts versus Li/Li⁺. In the first half cycle, lithium is removed from the metallic electrode and intercalated into the graphite electrode. When essentially full intercalation at the graphite electrode is complete, corresponding to about Li_{0.85}C₆, the voltage has dropped to approximately 0.01 volts, representing about 316 milliamp hours per gram, corresponding to about 6 milliamp hours based on 19.0 milligrams of active material. In the second half cycle, the lithium is deintercalated from the graphite and returned to the metallic electrode until the average voltage is approximately 2 volts versus Li/Li⁺. The deintercalation corresponds to approximately 263 milliamp hours per gram, representing approximately 5 milliamp hours based on 19.0 milligrams of active material. This completes an initial cycle. The percentage difference between the 11 milliamp hours per gram capacity “in”, and the 6 milliamp hours per gram capacity “out”, divided by the initial capacity “in”, corresponds to a surprisingly low 17% first cycle capacity loss. In the rest of FIG. 2, the cycling is repeated, maintaining high capacity.

### Example II Results

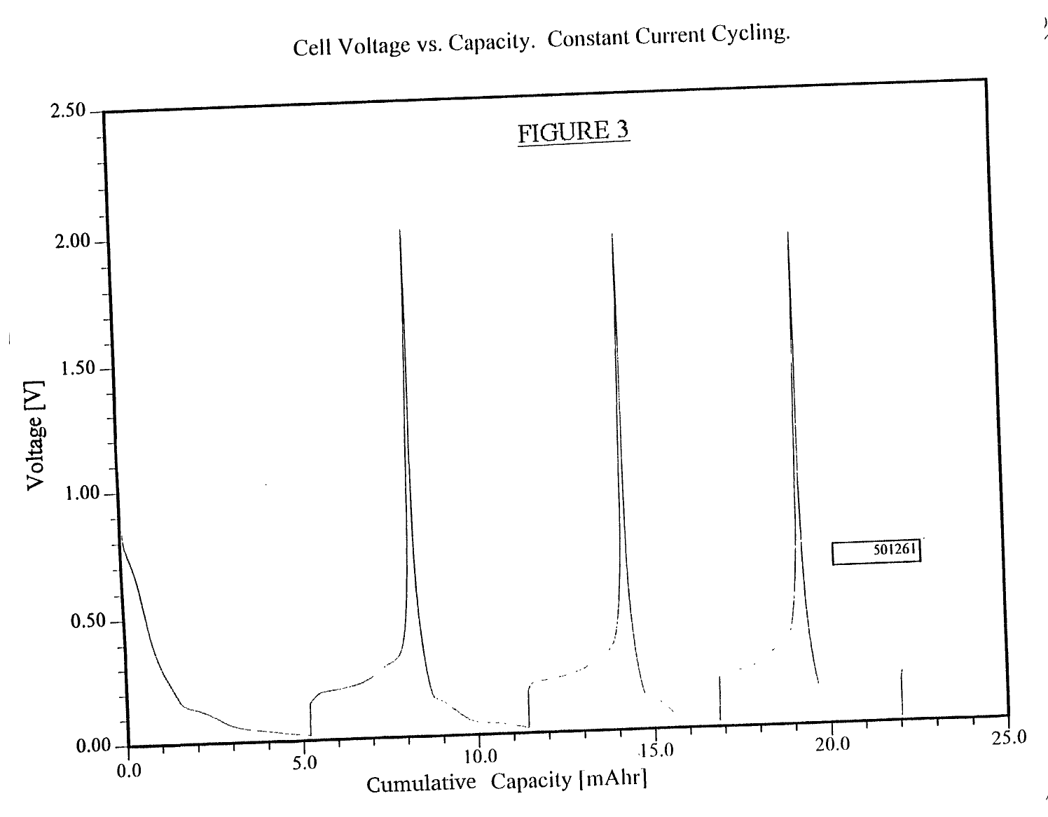

The results of constant current cycling (at 23° C.±1° C.) for the cell incorporating 5-methyl-y-butyrolactone are shown in FIG. 3, which represents a voltage/capacity plot of BG-35 graphite cycled with a lithium metal electrode using constant current cycling at ±0.2 milliamps per square centimeter, between 0.01 and 2.0 volts versus Li/Li⁺. Here, performance was also good, at a comparable cycle loss of about 15%.

### EXAMPLE III

### Comparative Example

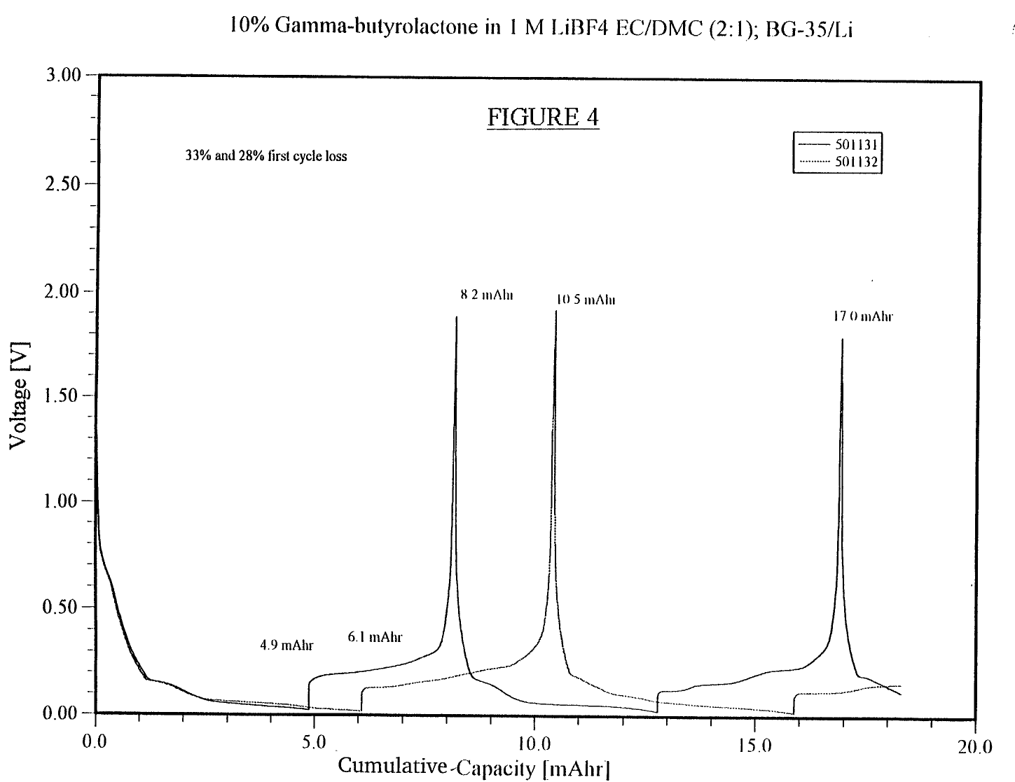

Additional cells were prepared in accordance with the method of Example I, except that the 3-methyl-γ-butyrolactone was replaced with γ-butyrolactone. Here, two cells having the γ-butyrolactone solvent demonstrated high first cycle loss: 33% and 28%, respectively. (FIG. 4.) As above, cycling was conducted at 23° C.±1° C.

### EXAMPLE IV

An electrode cathode was also fabricated by solvent casting a slurry of LMO, conductive carbon, binder, plasticizer, and solvent. The LMO used was LiMn₂O₄ supplied by Kerr-McGee (Soda Springs, ID); the conductive carbon used was SUPER P (MMM carbon), KYNAR FLEX 2801 brand PVdF/HFP copolymer was used as the binder along with a plasticizer, and electronic grade acetone was used as the solvent. The slurry was cast onto aluminum foil coated with polyacrylic acid/conductive carbon mixture. The slurry was cast onto glass and a free standing electrode was formed as the solvent was evaporated. The cathode electrode composition was approximately as follows on a dry weight % basis: 65% LiMn₂O₄; 5.5% graphite, 10% binder; and 19.5% plasticizer.

The electrochemical cell was prepared as noted above with respect to Example I. The electrolyte was prepared having the same composition as the electrolyte of Example I; namely, 10% by weight of 3-methyl-γ-butyrolactone and 90% by weight of EC/DMC (2:1) with 1 molar LiPF₆.

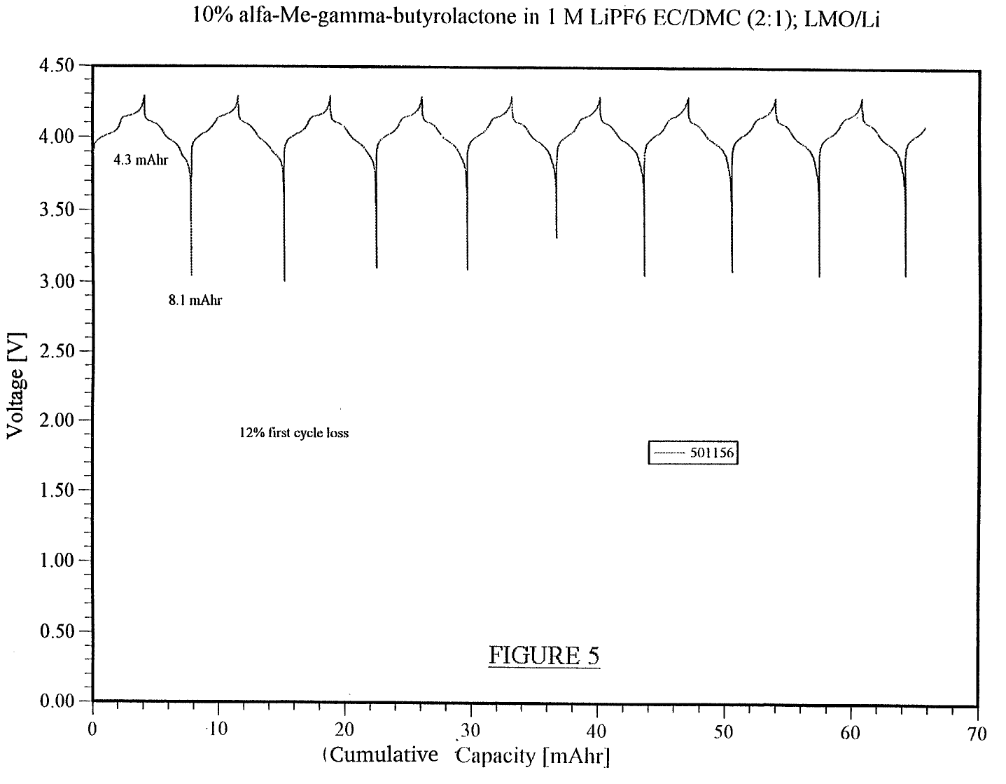

FIG. 5 contains the results of constant current cycling (at 23° C.±1° C.) and is a graph of cell voltage versus capacity for the cell of Example IV. FIG. 5 shows a voltage/capacity plot of LMO (nominally Li₁₊ₓMn₂₋ₓO₄ (−0.2≦×≦0.2)) cycled with a lithium metal electrode using constant current cycling at ±0.2 milliamps per square centimeter, between about 3 and 4.3 volts versus Li/Li⁺, using 30 milligrams of the LMO active material. The electrolyte is 1 molar LiPF₆ in a solution of 90% by weight of 2:1 EC/DMC and 10% by weight of the 3-methyl-γ-butyrolactone.

In an as-assembled, initial condition, the positive electrode active material is nominally LiMn₂O₄. The lithium is deintercalated from LMO during charging of the cell. When fully charged, optimally about 0.8 unit of lithium has been removed per formula unit of the original LiMn₂O₄. In this fully charged condition, the electrochemical potential versus lithium of the LMO is about 4.3 volts. The deintercalation of lithium from LMO results in approximately 118 milliamp hours per gram corresponding to 4.1 milliamp hours. Next, the cell is discharged whereupon a quantity of lithium is reintercalated into the LMO. The reintercalation corresponds to approximately 115 milliamp hours per gram or 4.0 milliamp hours, and the bottom of the curve corresponds to approximately 3 volts. The cell is then subsequently recharged whereupon a quantity of lithium ions is again deintercalated, returning to the region of approximately 4 volts. Charging and discharging continued successfully over a number of additional cycles. As can be seen from FIG. 5, the first cycle loss corresponded to only 12%, which is very good.

### EXAMPLE V

### Comparative Example

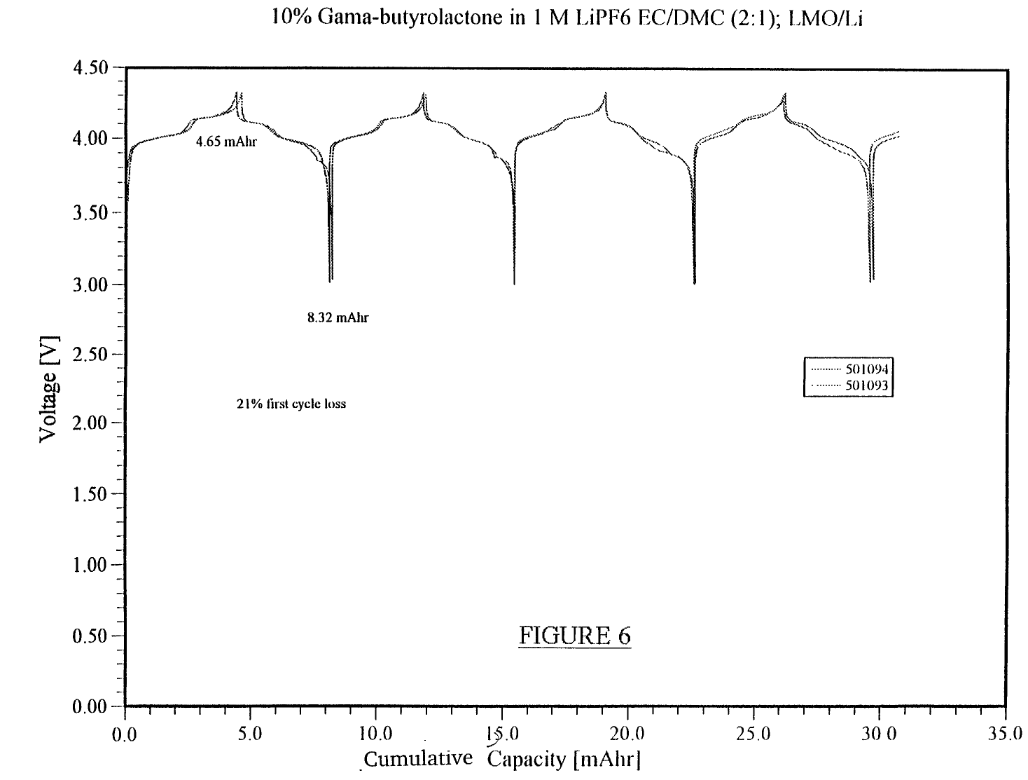

Two cells were prepared in accordance with the methods of Example IV except that the 3-methyl-γ-butyrolactone was replaced with γ-butyrolactone. The results of testing are shown in FIG. 6. Here there is a high first cycle loss on the order of 21%. As before, current cycling was at 23° C.±1° C. This high loss occurred for both cells.

### EXAMPLE VI And VII

### Example VI Cell Preparation

A rocking chair battery was prepared comprising a graphite anode, an intercalation compound cathode, and a novel electrolyte solvent of the invention. The negative electrode comprising BG-35 was prepared as described above. The LMO positive electrode was also prepared in accordance with the above description. The active mass of the negative electrode was 330 milligrams and the active mass of the positive electrode was 950 milligrams. An electrolyte solution of 10% by weight 3-methyl-γ-butyrolactone and 90% by weight EC/DMC (2:1) with one molar LiPF₆ was prepared. The two electrode layers were arranged with a polymeric electrolyte layer in between, and the layers were laminated together using heat and pressure as per the Bell Communications Research patents incorporated herein by reference above. The electrolyte solution was added to the assembled layers in a cell.

### Example VII Cell Preparation

A cell was prepared in accordance with the methods of Example VI except that the 3-methyl-γ-butyrolactone was replaced with γ-butyrolactone.

### Results

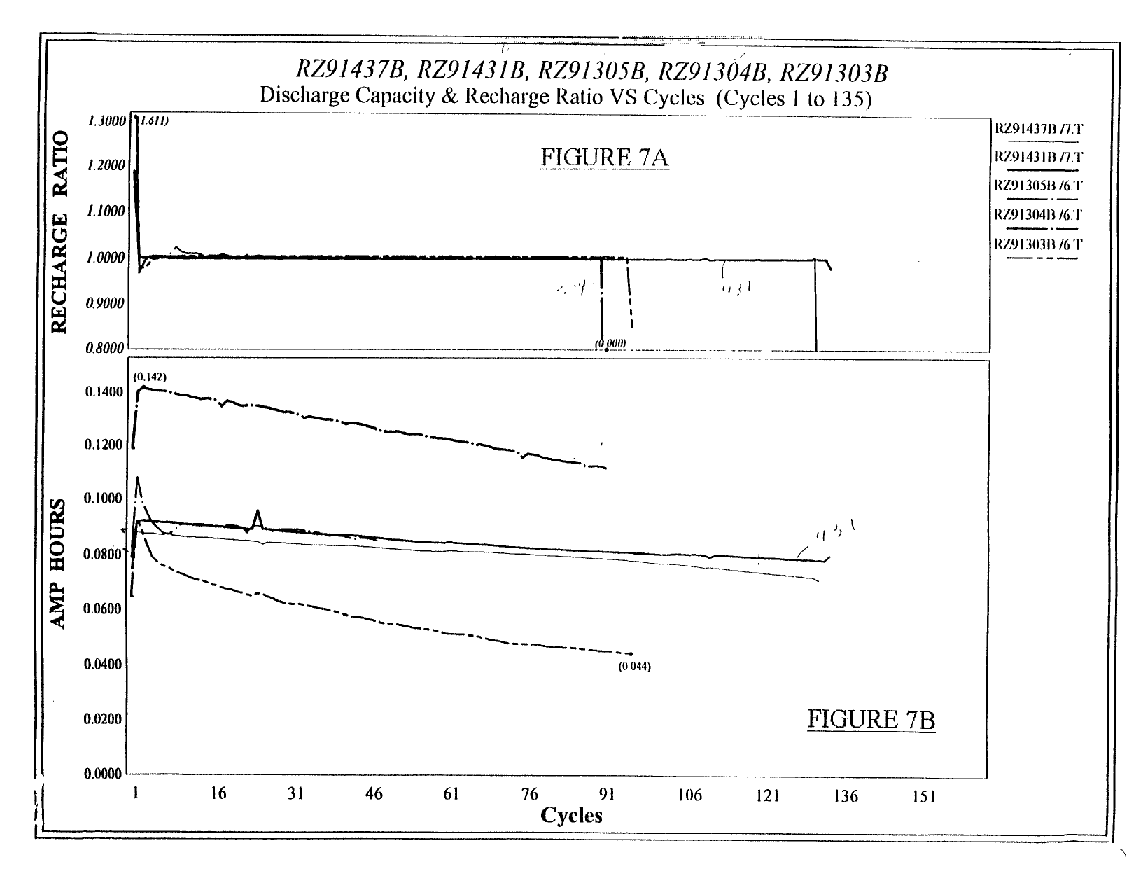

The results of testing the cell of Examples VI is shown in FIG. 7, a two-part graph: FIG. 7A represents the excellent rechargeability; and FIG. 7B shows the excellent cyclability and capacity of the cell (RZ91431) prepared in accordance with Example VI. The capacity was determined at constant current cycling (at 23° C.±1° C.) for over 120 cycles consistent with the test parameters described herein. FIG. 7 shows long cycle life demonstrated by the relatively slow capacity fade with cycle numbers for cell RZ91431. The recharge ratio data shows the absence of any appreciable side reactions and decompositions over the extended life cycling. This can be more particularly seen from FIG. 7A. The recharge ratio maintains its value exceptionally close to 1. The cell maintains over 80% of its capacity over extended cycling to 120 cycles. The combination of slow, minimal capacity fade along with excellent recharge ratio demonstrates the absence of any appreciable side reactions. This cycling with low capacity fade indicated good compatibility of the 3-methyl-γ-butyrolactone in the system which stabilized the electrolyte. FIG. 7 also contains the results of cycling the comparative cell of Example VII labeled as RZ91304. The dashed line represents this cell and shows its more significant capacity fade and cell exhaustion after less than 90 cycles.

Advantageously, the additive of the invention is usable with a variety of solvents; solvents are selected from such mixtures as DMC, DEC, DPC, EMC, EC, PC, butylene carbonate, other lactones, esters, glymes, sulfoxides, sulfolanes, etc. The most preferred solvents are EC/DMC. In addition, the range of salt content may be relatively broad. The salt content ranges from about 5% to 65% by weight, preferably from about 8% to 35% by weight. Physical characteristics of the lactones are given in Table I. Physical characteristics of exemplary aprotic, polar solvents are given in Table II. Any amount of the lactones added to the solvent is helpful. Practical amounts are up to 30% by weight of the solvent mixture, desirably up to about 20%, and most desirably up to about 10%.

It should be noted that the most preferred EC/DMC/lactone solvent mixture provides a number of advantages. EC is a high dielectric solvent and enhances dissociation of the salt. DMC has low viscosity and promotes mobility of ions. The lactone enhances the thermal stability of LiPF₆, and seems to stabilize co-solvents. The same advantages apply to other lithium-fluorine salts such as LiBF₄ and LiAsF₆.

In summary, the invention solves the problems associated with conventional electrolytes. Solvents containing DMC have always been a problem since DMC readily boils off. EC readily solidifies, and it is necessary for the cell to achieve a temperature of 40° C. to melt the EC and prevent it from solidifying. In addition, mixtures of DMC/EC lacking the novel lactone solvents of the present invention have been found to result in decomposition evidenced by solution color change and/or by formation of gas. In contrast, electrolyte solvents according to the present invention provide a highly desirable wide temperature operating range while avoiding decomposition of cell components. It is thought that the solvents of the invention also help overcome problems associated with reactive active materials and avoids the consequences of catalytic reaction which catalyzes decomposition of electrolyte solvent. Therefore, the solvents of the invention are an improvement over conventional solvents.

Based on the performance above, the electrolytes of the invention are considered to be usable with a variety of carbonaceous active materials. This is demonstrated by the surprisingly better performance of EC/DMC/3-methyl-γ-butyrolactone and EC/DMC/5-methyl-γ-butyrolactone as compared to EC/DMC and EC/DMC/γ-butyrolactone. The EC/DMC is the most problematic. The carbonaceous materials (carbons) usable with the electrolyte of the invention range from highly structural to amorphous and from powders to fibers. Such materials have well documented physical properties. Some carbons are highly structured, highly crystalline, highly graphitic, anisotropic graphites having a nearly perfect layered structure and preferably formed as synthetic graphites and heat treated up to about 3000° C. Examples are the SFG and the KS graphites as supplied by the manufacturer Lonza G. & T., Ltd. (Sins, Switzerland). Some carbons are graphitic carbons which have relatively very large crystal size (L_{c} greater than 2000) and are fully graphitized. BG grades from Superior are purified natural graphite. Some carbons are non-graphitic carbons. These are considered amorphous, non-crystalline, disordered, and are generally petroleum cokes and carbon blacks, as such, supplied by Lonza under the designation FC-250 and by Conoco (USA) under the designations XP and X-30.

TABLE I
Lactone Solvent Properties

| | γ-butyro- | | |
|---|---|---|---|
| | lactone | 3-methyl- | 5-methyl-GBL |
| | (GBL) | GBL | (γ-valerolactone) |
| Molecular formula | C4H6O2 | C5H8O2 | C5H8O2 |
| Boiling Temperature (° C.) | 204 | | 206 |
| Melting Temperature (° C.) | −43.3 | | −31 |
| Density (g/cm³) | 1.1284 | 1.063 | 1.0465 |
| Solution Conductivity (S/cm) | | | |
| Viscosity (cp) at 25° C. | | | |
| Dielectric Constant at 20° C. | | | |
| Molecular Weight | 86.09 | 100.12 | 100.12 |
| H₂O Content | | | |
| Electrolytic Conductivity | | | |
| (mS/cm) 23° C. 1M LiPF₆ | | | |
| | 4-propyl- | β-propio- | |
| | GBL | lactone | 5-ethyl-GBL |
| Molecular formula | C7H12O2 | C3H4O2 | C6H10O2 |
| Boiling Temperature (° C.) | | 162 | 215.5 |
| Melting Temperature (° C.) | | −33.4 | −18 |
| Density (g/cm³) | | | 1.0261 |
| Solution Conductivity (S/cm) | | | |
| Viscosity (cp) at 25° C. | | | |
| Dielectric Constant at 20° C. | | | |
| Molecular Weight | | 72.06 | 114.14 |
| H₂O Content | | | |
| Electrolytic Conductivity | | | |
| (mS/cm) 23° C. 1M LiPF₆ | | | |

TABLE II
Characteristics of Organic Solvents

| | PC | VC | EC | DMC |
|---|---|---|---|---|
| Boiling Temperature (C.) | 240 | 162 | 248 | 91.0 |
| Melting Temperature | −49 | 22 | 39-40 | 4.6 |
| (C.) | | | | |
| Density (g/cm³) | 1.198 | 1.35 | 1.322 | 1.071 |
| Solution Conductivity | 2.1 × 10⁻⁹ | — | <10⁻⁷ | <10⁻⁷ |
| (S/cm) | | | | |
| Viscosity (cp) at 25° C. | 2.5 | — | 1.86 | 0.59 |
| | | | (at 40° C.) | |
| Dielectric Constant at | 64.4 | — | 89.6 | 3.12 |
| 20° C. | | | (at 40° C.) | |
| Molecular Weight | 102.0 | 86.047 | 88.1 | 90.08 |
| H₂O Content | <10 ppm | — | <10 ppm | <10 ppm |
| Electrolytic Conductivity | 5.28 | — | 6.97 | 11.00 |
| (mS/cm) 20° C. 1M | | | | (1.9 mol) |
| LiAsF₆ | | | | |
| | DEC | BC | MEC | DPC |
| Boiling Temperature (C.) | 126 | 230 | 107 | 167-168 |
| Melting Temperature | −43 | — | −55 | — |
| (C.) | | | | |
| Density (g/cm³) | 0.98 | 1.139 | 1.007 | 0.944 |
| Solution Conductivity | <10⁻⁷ | <10 − 7 | 6 × 10⁻⁹ | <10⁻⁷ |
| (S/cm) | | | | |
| Viscosity (cp) at 25° C. | 0.75 | 2.52 | 0.65 | — |
| Dielectric Constant at | 2.82 | — | — | — |
| 20° C. | | | | |
| Molecular Weight | 118.13 | 116.12 | 104.10 | 146.19 |
| H₂O Content | <10 ppm | <10 ppm | <10 ppm | <10 ppm |
| Electrolytic Conductivity | 5.00 | <3.7 | — | — |
| (mS/cm) 20° C. 1M | (1.5 mol) | | | |
| LiAsF₆ | | | | |

TABLE III

| | |
|---|---|
| Carbon Material | BG-35 |
| Surface Area (m²/g) (BET) | 7 |
| Coherence Length L_{c} (nm) | >1000 |
| Density (g/cm³)² | 2.1 |
| Particle Size¹ | <36 |
| Median Size d₅₀ (μm) | 17 |
| Interlayer Distance c/2 (nm) | N/A |

¹Maximum size for at least 90% by weight of graphite particles.
²In xylene.

While this invention has been described in terms of certain embodiments thereof, it is not intended that it be limited to the above description, but rather only to the extent set forth in the following claims.

1. An electrochemical cell comprising:
first electrode;
a second electrode; and
an electrolyte comprising a solvent mixture and a solute, said solute comprising a lithium salt, and said solvent mixture comprising a lactone selected from the group consisting of methylated γ-butyrolactone, ethylated γ-butyrolactone, propylated γ-butyrolactone, and β-propiolactone, and at least one other organic solvent.

2. The electrochemical cell of claim 1, wherein said at least one other organic solvent is selected from the group consisting of carbonates, lactones, propionates, five member hetercyclic ring compounds, and organic solvent compounds having a low alkyl (1-4 carbon) group connected through an oxygen to a carbon, and comprising C—O—C bonds.

3. The electrochemical cell of claim 1, wherein said at least one other organic solvent comprises an organic carbonate solvent.

4. The electrochemical cell of claim 3, wherein said organic carbonate solvent is selected from the group consisting of methyl ethyl carbonate, diethyl carbonate, dipropyl carbonate, dimethyl carbonate, butylene carbonate, dibutyl carbonate, vinylene carbonate, diethoxy ethane, ethylene carbonate, propylene carbonate, and mixtures thereof.

5. The electrochemical cell of claim 1, wherein said at least one other organic solvent comprises ethylene carbonate (EC) and dimethyl carbonate (DMC).

6. The electrochemical cell of claim 5, wherein the weight ratio of said EC and said DMC in said solvent mixture is approximately 2:1.

7. The electrochemical cell of claim 1, wherein the percent by weight of said lactone present in said solvent mixture is in the range of up to approximately 30%.

8. The electrochemical cell of claim 1, wherein the percent by weight of said lactone present in said solvent mixture is in the range of up to approximately 20%.

9. The electrochemical cell of claim 1, wherein the percent by weight of said lactone present in said solvent mixture is in the range of up to approximately 10%.

10. The electrochemical cell of claim 1 wherein said first electrode comprises a lithium-containing active material.

11. The electrochemical cell of claim 1 wherein said second electrode comprises an intercalation active material.

12. An electrochemical cell comprising:
a first electrode;
a second electrode; and
an electrolyte comprising a solvent mixture and a solute, said solvent mixture comprising a lactone selected from the group consisting of 3-methyl-γ-butyrolactone and 5-methyl-γ-butyrolactone, and at least one other organic solvent.

13. The electrochemical cell of claim 12, wherein said at least one other organic solvent is selected from the group consisting of carbonates, lactones, propionates, five member hetercyclic ring compounds, and organic solvent compounds having a low alkyl (1-4 carbon) group connected through an oxygen to a carbon, and comprising C—O—C bonds.

14. The electrochemical cell of claim 12, wherein said at least one other organic solvent comprises an organic carbonate solvent.

15. The electrochemical cell of claim 14, wherein said organic carbonate solvent is selected from the group consisting of methyl ethyl carbonate, diethyl carbonate, dipropyl carbonate, dimethyl carbonate, butylene carbonate, dibutyl carbonate, vinylene carbonate, diethoxy ethane, ethylene carbonate, propylene carbonate, and mixtures thereof.

16. The electrochemical cell of claim 12, wherein said at least one other organic solvent comprises ethylene carbonate (EC) and dimethyl carbonate (DMC).

17. The electrochemical cell of claim 16, wherein the weight ratio of said EC and said DMC in said solvent mixture is approximately 2:1.

18. The electrochemical cell of claim 12, wherein the percent by weight of said lactone present in said solvent mixture is in the range of up to approximately 30%.

19. The electrochemical cell of claim 12, wherein the percent by weight of said lactone present in said solvent mixture is in the range of up to approximately 20%.

20. The electrochemical cell of claim 12, wherein the percent by weight of said lactone present in said solvent mixture is in the range of up to approximately 10%.

21. A lithium ion electrochemical cell comprising:
a first electrode comprising an active material comprising a lithium-containing compound;
a second electrode; and
an electrolyte comprising a solvent mixture and a solute, said solute comprising a lithium salt, and said solvent mixture comprising a methylated γ-butyrolactone, and at least one other organic solvent.

22. The lithium ion electrochemical cell of claim 21, wherein said at least one other organic solvent is selected form the group consisting of carbonates, lactones, propionates, five member hetercyclic ring compounds, and organic solvent compounds having a low alkyl (1-4 carbon) group connected through an oxygen to a carbon, and comprising C—O—C bonds.

23. The lithium ion electrochemical cell of claim 21, wherein said at least one other organic solvent comprises an organic carbonate solvent.

24. The lithium ion electrochemical cell of claim 23, wherein said methylated γ-butyrolactone is selected from the group consisting of 3-methyl-γ-butyrolactone, 5-methyl-γ-butyrolactone, and mixtures thereof.

25. The lithium ion electrochemical cell of claim 21, wherein said at least one other organic solvent comprises ethylene carbonate (EC) and dimethyl carbonate (DMC).

26. The electrochemical cell of claim 25, wherein the weight ratio of said EC and said DMC in said solvent mixture is approximately 2:1.

27. The electrochemical cell of claim 26, wherein the percent by weight of said lactone present in said solvent mixture is in the range of up to approximately 30%.

28. The lithium ion electrochemical cell of claim 21, wherein said lithium-containing compound is selected from the group consisting of lithium manganese oxide, LiNiO₂, LiCoO₂, and mixtures thereof .

29. The lithium ion electrochemical cell of claim 28, wherein said lithium manganese oxide is represented by the nominal general formula Li₁₊ₓMn₂₋ₓO₄ (−0.2<×<0.2).
